(19) United States
(12) Patent Application Publication
(10) Pub. No.: US 2023/0081386 A1
(43) Pub. Date: Mar. 16, 2023

(54) VEHICLE AND CONTROL METHOD THEREOF

(71) Applicants: Hyundai Motor Company, Seoul (KR); Kia Corporation, Seoul (KR)

(72) Inventors: Jaemin Moon, Yongin (KR); Minjae Park, Seongnam (KR); Sungwang Kim, Seoul (KR)

(21) Appl. No.: 17/884,338

(22) Filed: Aug. 9, 2022

(30) Foreign Application Priority Data
Sep. 13, 2021 (KR) 10-2021-0121641

(51) Int. Cl. G10L 15/22; G06F 3/14; G06F 3/16; H04R 1/02; H04R 3/12; G10L 13/02; H04R 1/40; G08G 1/0962; B60K 35/00

(52) U.S. Cl. CPC G10L 15/22; G06F 3/14; G06F 3/165; H04R 1/025; H04R 3/12; G10L 13/02; H04R 1/403; G06F 3/167; G08G 1/0962; B60K 35/00; G10L 2015/223; H04R 2499/13; G10L 2015/225; B60K 2370/148; B60K 2370/152; B60K 2370/157

(57) ABSTRACT

Provided is a vehicle, comprising: a voice receiver configured to acquire a user voice input; a speaker provided inside the vehicle; a display provided inside the vehicle; and a controller configured to control the voice receiver, the speaker and the display, wherein the controller is configured to: acquire a control command from the user voice input, wait for receiving a subsequent control command for a predetermined waiting time after operating a control target based on the control command, and control at least one of the speaker or the display to provide a feedback for notifying that the control target is in a subsequent controllable state.

### CROSS-REFERENCE TO RELATED APPLICATION

This application claims, under 35 U.S.C. § 119(a), the benefit of Korean Patent Application No. 10-2021-0121641, filed on Sep. 13, 2021 in the Korean Intellectual Property Office, the disclosure of which is incorporated herein by reference in its entirety.

### BACKGROUND

### Technical Field

Embodiments of the present disclosure relate to a vehicle and a control method thereof that may acquire a user voice input and control various devices and functions of the vehicle based on the user voice input.

### Description of the Related Art

As speech recognition technologies develop, speech recognition technologies are applied to vehicles for improving user convenience and driving concentration. For example, a user in a vehicle may make an utterance to operate a device of a vehicle. The user voice input may be obtained through a microphone, and the vehicle may operate a device corresponding to the user voice input.

For instance, after inputting a command for operating a multimedia device, a user may input another command for the multimedia device. In this instance, when a system of the vehicle does not store operation information of the multimedia device, another device may be controlled with a subsequent command. Accordingly, a control system of the vehicle may be configured to store the operation information of the controlled device for a certain period of time after controlling the device, in order to prevent unintended subsequent control.

However, the user may not recognize how long a subsequent control is available and for which device is subsequent controllable.

### SUMMARY

Objects of the present disclosure provide a vehicle and a control method thereof that may provide a feedback for notifying that a control target is in a subsequent controllable state.

Additional objects of the present disclosure will be set forth in part in the description which follows and, in part, will be obvious from the description, or may be learned by practice of the disclosure.

According to an exemplary embodiment of the present disclosure, there is provided a vehicle, comprising: a voice receiver configured to acquire a user voice input; a speaker provided inside the vehicle; a display provided inside the vehicle; and a controller configured to control the voice receiver, the speaker and the display, wherein the controller is configured to: acquire a control command from the user voice input, wait for receiving a subsequent control command for a predetermined waiting time after operating a control target based on the control command, and control at least one of the speaker or the display to provide a feedback for notifying that the control target is in a subsequent controllable state.

The controller may be configured to determine at least one of: providing a visual feedback through the display; or providing a sound feedback through the speaker, based on predetermined feedback guide information related to the control target.

The controller may be configured to control the display to display at least one of a text or a graphic object representing the control target, as the visual feedback.

The controller may be configured to control the speaker to output a predetermined sound effect related to the control target, as the sound feedback.

The controller may be configured to control the speaker to output an artificial intelligence (AI) speech, related to the control target which is in the subsequent controllable state, as the sound feedback, in response to the user voice input calling an AI application.

A plurality of speakers may be provided at a plurality of positions inside the vehicle, and the controller may be configured to determine at least one speaker to output the sound feedback among the plurality of speakers based on a position of the control target.

The controller may be configured to provide the sound feedback after reducing a volume of audio content, based on the audio content being output by a media application through the speaker.

The voice receiver may be a microphone.

The vehicle may further comprise an indicator provided in a center fascia of the vehicle and configured to indicate an operation state of the control target by light emission, and the controller may be further configured to control the indicator to blink to notify that the control target is in the subsequent controllable state.

The vehicle may further comprise a button configured to acquire a user input, and the controller may be further configured to acquire the control command from the user voice input through the voice receiver or the user input through the button.

According to an exemplary embodiment of the present disclosure, there is provided a method for controlling a vehicle, the method comprising: acquiring a control command from a user voice input; waiting for receiving a subsequent control command for a predetermined waiting time after operating a control target based on the control command; and providing a feedback for notifying that the control target is in a subsequent controllable state for the predetermined waiting time, through at least one of a speaker or a display.

The providing of the feedback includes determining at least one of: providing a visual feedback through the display; or providing a sound feedback through the speaker, based on predetermined feedback guide information related to the control target.

The providing of the visual feedback may comprise displaying at least one of a text or a graphic object representing the control target, on the display.

The providing of the sound feedback may comprise outputting a predetermined sound effect related to the control target, through the speaker.

The providing of the sound feedback may comprise outputting an AI speech, related to the control target which is in the subsequent controllable state, through the speaker, in response to the user voice input calling an AI application.

A plurality of speakers may be provided at a plurality of positions inside the vehicle, and the providing of the sound feedback may further comprise determining at least one speaker to output the sound feedback among the plurality of speakers based on a position of the control target.

The providing of the sound feedback may further comprise providing the sound feedback after reducing a volume of audio content, based on the audio content being output by a media application through the speaker.

An indicator may be provided in a center fascia of the vehicle to indicate an operation state of the control target by light emission, and the control method may further comprise controlling the indicator to blink to notify that the control target is in the subsequent controllable state.

A button may be provided in a center fascia of the vehicle to acquire a user input, and the control command may be acquired from the user voice input through a voice receiver or the user input through the button.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates an exterior of a vehicle according to an exemplary embodiment;

FIG. 2 illustrates an interior of a vehicle according to an exemplary embodiment;

FIG. 3 illustrates speakers provided inside a vehicle according to an exemplary embodiment;

FIG. 4 is a control block diagram of a vehicle according to an exemplary embodiment;

FIG. 5 is a flowchart illustrating a control method of a vehicle according to an exemplary embodiment;

FIG. 6 is a flowchart illustrating a method of providing a feedback described in FIG. 5;

FIG. 7 is a table illustrating feedback guide information related to a control target;

FIG. 8 illustrates an example of visual feedback provided through a display;

FIG. 9 illustrates an example of sound feedback provided through a speaker;

FIG. 10 illustrates an example of an input of a subsequent control command and an operation of a vehicle according to the subsequent control command; and

FIGS. 11 and 12 illustrate another example of visual feedback provided through a display.

### DETAILED DESCRIPTION

Like reference numerals throughout the specification denote like elements. Also, this specification does not describe all the elements according to embodiments of the disclosure, and descriptions well-known in the art to which the disclosure pertains or overlapped portions are omitted.

It will be understood that when an element is referred to as being “connected” to another element, it can be directly or indirectly connected to the other element, wherein the indirect connection includes “connection” via a wireless communication network.

It will be understood that the terms “include” when used in this specification, specify the presence of stated features, integers, steps, operations, elements, and/or components, but do not preclude the presence or addition of one or more other features, integers, steps, operations, elements, components, and/or groups thereof.

It is to be understood that the singular forms are intended to include the plural forms as well, unless the context clearly dictates otherwise.

The terms such as “˜part”, “˜member”, “˜module”, “˜block”, and the like may refer to at least one process processed by at least one hardware or software. According to embodiments, a plurality of “˜part”, “˜member”, “˜module”, “˜block” may be embodied as a single element, or a single of “˜part”, “˜member”, “˜module”, “˜block” may include a plurality of elements.

It will be understood that, although the terms first, second, etc. may be used herein to describe various elements, these elements should not be limited by these terms.

Reference numerals used for method steps are just used for convenience of explanation, but not to limit an order of the steps. Thus, unless the context clearly dictates otherwise, the written order may be practiced otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

Hereinafter, embodiments will be described in detail with reference to the accompanying drawings.

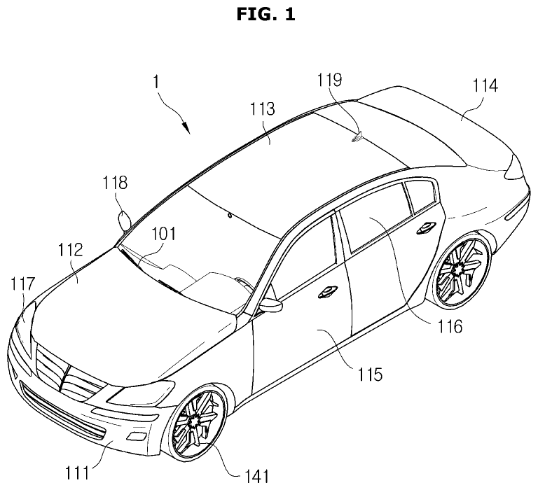

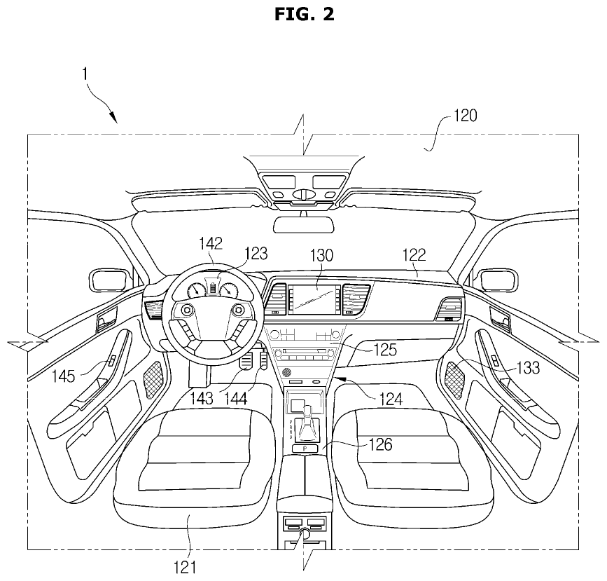

FIG. 1 illustrates an exterior of a vehicle according to an exemplary embodiment. FIG. 2 illustrates an interior of a vehicle according to an exemplary embodiment.

Referring to FIGS. 1 and 2, a vehicle 1 may include a vehicle body having an exterior and an interior 120, a chassis where mechanical devices for travelling are mounted, as a remaining portion except for the vehicle body, and a vehicle wheel 141. The exterior of the vehicle 1 may include a front panel 111, a bonnet 112, a sunroof 113, a trunk 114, a door 115, a window 116, a lamp 117, a side mirror 118 and/or an antenna 119. Also, a window glass and a wiper 101 may be provided on a front surface of the vehicle 1.

The sunroof 113 may be an electric sunroof. The window 116 may be provided to be open or closed on the door 115. The lamp 117 may be configured to light up the front of the vehicle 1 to allow a driver to easily see the surroundings and provide a signal to other vehicles and pedestrians as a communication function. The side mirror 118 may be configured to provide the driver with a field of view behind and to the side of the vehicle 1. The antenna 119 may be configured to transmit/receive a wireless communication signal. For example, the antenna 119 may be configured to transmit/receive a global positioning system (GPS) satellite signal, a broadcasting signal, a communication signal with other vehicles (V2V) and/or a communication signal with infrastructure (V2I).

Referring to FIG. 2, the interior 120 of the vehicle 1 may include a seat 121, a dashboard 122, a cluster 123 and a center fascia 124. The seat 121 may be provided inside the vehicle 1 in order for an occupant to sit on for the occupant's safety and comfort. The seat 121 may be divided into a driver's seat, a passenger's seat and a rear seat according to its position. A position and backrest angle of the seat 121 may be adjustable automatically or manually. Also, the vehicle 1 may include a steering wheel 142 of a steering part configured for adjusting a driving direction of the vehicle 1, a brake pedal 143 configured for braking the vehicle 1, and an accelerator pedal 144 configured for accelerating the vehicle 1.

The cluster 123 may be placed on the dashboard 122, and may include a variety of indicator lights and warning lights. For example, the cluster 123 may include a tachometer, speedometer, coolant thermometer, fuel gauge, turn indicator, high beam indicator, warning light, seat belt warning light, odometer, shift lever indicator, door open warning light, engine oil warning light, and/or low oil warning light. The cluster 123 may be implemented digitally and may include a display.

Also, a speaker 133 may be provided on the dashboard 122. As will be described later, the speakers 133 may be installed at various positions inside the vehicle 1. For example, the speakers 133 may be installed inside the door 115 and on a rear dashboard. An air vent of an air conditioner may also be disposed on the dashboard 122.

Various components may be disposed on the center fascia 124. For instance, provided may be a control panel 125 including a variety of buttons 125a and indicators 125b, a console 126 provided between the driver's seat and the passenger's seat, and a display 130. The console 126 may be provided with a space for placing objects such as a shift lever, buttons for driving, neutral gear, parking and side brake and a cup. The control panel 125 and/or the console 126 may be provided with a dial, a touch pad, and/or a multi-interface for connection with an external device.

An inputter such as a button, a touch pad, or a dial may be provided on the steering wheel 142, an armrest, a door handle and the seat 121. For example, a window button 145 configured for opening or closing a window may be provided on an inside surface of the door 115.

The buttons 125a, the display 130 and the speaker 133 provided inside the vehicle 1 may function as an infotainment device. The infotainment device may also be referred to as an audio video navigation (AVN) device. For example, the display 130 may be configured to display an image for at least one selected by a user from among an audio function, video function, navigation function, broadcasting function (DMB function), radio function, content playback function, and Internet search function.

The display 130 may be embedded in the dashboard 122 or installed on the dashboard 122 to be vertically stood. The display 130 may include a light emitting diode (LED) panel, an organic light emitting diode (OLED) panel, or a liquid crystal display (LCD) panel. The display 130 may include a touch screen configured to receive a user's touch.

In addition, the vehicle 1 may include various devices for driving the vehicle 1. For example, the vehicle 1 may include a power generation device, power transmission device, driving assistance device, steering device, braking device, acceleration device, suspension device, transmission device, fuel device, wheels, and/or battery.

Also, the vehicle 1 may include a plurality of electronic components such as an engine management system (EMS), a transmission control unit (TCU), an electronic brake control module (EBCM), an electronic power steering (EPS), an AVN system 210, an air conditioning system 220, a body control system 230, and a driver assistance system (DAS) 240. When the vehicle 1 is an electric vehicle, an engine, a transmission, the EMS, and the TCU may not be provided in the vehicle 1.

The electronic components of the vehicle 1 may be configured to communicate with each other via a vehicle communication network (NT). For example, the electronic components may be configured to transmit/receive data through Ethernet, media oriented systems transport (MOST), FlexRay, controller area network (CAN), local interconnect network (LIN), and the like.

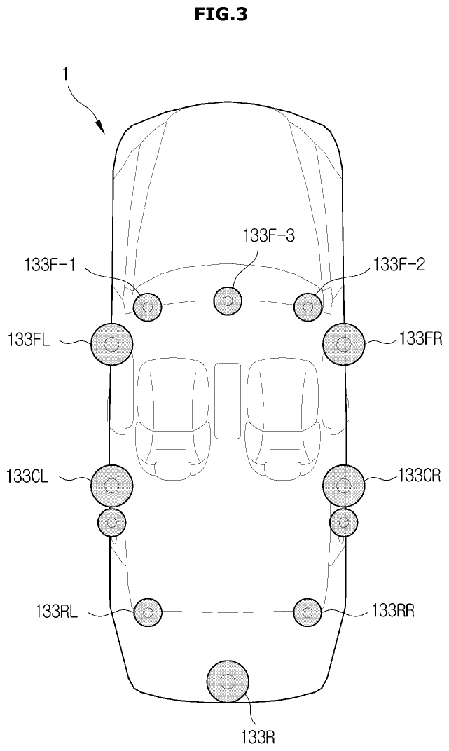

FIG. 3 illustrates speakers that may be provided inside a vehicle according to an exemplary embodiment.

Referring to FIG. 3, the speakers 133 may be provided at various positions inside the vehicle 1. For instance, the speakers 133 may include front speakers 133F-1, 133F-2 and 133F-3, a front left speaker 133FL, a front right speaker 133FR, center speakers 133CL and 133CR, a rear speaker 133R, a rear left speaker 133RL and a rear right speaker 133RR. Each of the plurality of speakers 133 of the vehicle 1 may be controlled independently.

The front speakers 133F-1, 133F-2 and 133F-3 may be provided on the dashboard 122 and may include the first front speaker 133F-1, the second front speaker 133F-2 and the third front speaker 133F-3. The front left speaker 133FL may be provided in a front left door and the front right speaker 133FR may be provided in a front right door. The center speakers 133CL and 133CR may include the center right speaker 133CR and the center left speaker 133CL provided close to a B pillar in a rear left door. The rear speaker 133R may be provided in the center of the rear dashboard. The rear left speaker 133RL and the rear right speaker 133RR may be provided on the left and right sides of the rear dashboard, respectively.

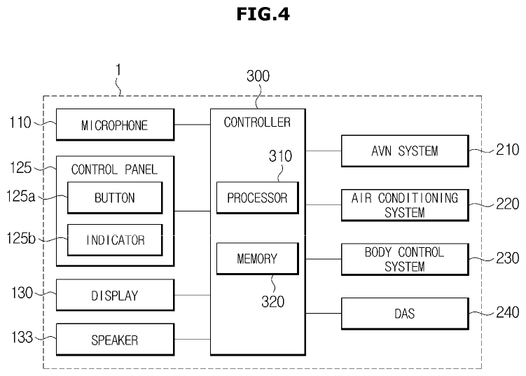

FIG. 4 is a control block diagram of a vehicle according to an exemplary embodiment.

Referring to FIG. 4, the vehicle 1 may include a voice receiver 110 (e.g., a microphone), the control panel 125, the display 130, the speaker 133, the AVN system 210, the air conditioning system 220, the body control system 230, the DAS 240 and a controller 300. The controller 300 may be electrically connected to and control constituent components of the vehicle 1. The constituent components controlled by the controller 300 may be referred to as a control target.

The microphone 110 may be provided inside the vehicle 1 and acquire a user voice. The microphone 110 may be provided at various positions in the vehicle 1. For example, the microphone 110 may be mounted on the dashboard 122, the center fascia 124 and/or the steering wheel 142. The controller 300 may be configured to acquire a control command from a user voice input acquired through the microphone 110, and may be configured to control the control target to operate based on the control command. For instance, a window control command for opening or closing the window 116 may be included in the user voice input. The controller 300 may be configured to control an operation of the window 116 according to the window control command. The control command may be acquired by a user input through the buttons 125a.

The control panel 125 may include the buttons 125a and the indicators 125b. The buttons 125a may be provided to start or stop the operation of the control target. The indicators 125b may be configured to display an operation state of the control target by light emission.

The buttons 125a and the indicators 125b may be provided on the console 126 and the control panel 125, as well as at various positions in the vehicle 1. The control panel 125 may be provided on the center fascia 124 as well as on other positions. For example, an inputter like the control panel 125 may be provided on a steering device (steering wheel), an armrest, the door 115 and/or the seat 121.

For instance, the buttons 125a may include an artificial intelligence (AI) execution button configured for calling an AI application, a start button configured for inputting a start command, an air control button configured for operating an air conditioner, and the window button 145 for opening or closing the window. In addition to the above, various types of buttons 125a related to a variety of functions may be provided in the vehicle 1. Also, the buttons 125a may be provided in various forms. For example, the buttons 125a may be provided as a push button, a toggle button or a touch button. The user may input the control command by manipulating the buttons 125a.

The indicators 125b may be configured to indicate an operation state of the control target and whether the control target is in a subsequent controllable state. The indicators 125b may be provided as a LED. For example, based on a user input (e.g. a push input or touch input) for the air control button to operate the air conditioner, the indicator 125b corresponding to the air control button may be turned on or off. Also, the indicator 125b may be configured to blink in order to indicate that a subsequent controllable for the air conditioner is available.

The display 130 may be configured to display vehicle state information and driving information. The display 130 may be configured to display various information related to functions, states and/or operations of the vehicle 1. The display 130 may be configured to display a graphic user interface (GUI) including graphic elements (e.g. icons, texts, and images) for executing or setting various functions of the vehicle 1. The GUI may be configured to interact with the user input. For example, the display 130 may be configured to display a driving route to a destination set by a driver and various GUIs for providing the driving route.

Also, the display 130 may be configured to provide visual feedback for notifying that a control target in operation is in a subsequent controllable state. The visual feedback may be determined based on predetermined feedback guide information related to the control target. The visual feedback may be provided as at least one of a text or a graphic object representing the control target.

The speakers 133 may be configured to output sound (e.g. voice, warning sound) related to the functions, states and/or operations of the vehicle 1. The speakers 133 may be configured to output sound feedback for notifying that a control target is in a subsequent controllable state. The sound feedback may be determined based on predetermined feedback guide information. The feedback guide information may be stored in a memory 320 in advance.

The sound feedback may include a predetermined sound effect related to the control target and/or an AI speech related to the control target which is in the subsequent controllable state. At least one speaker to output the sound feedback may be determined among the plurality of speakers 133 provided in the vehicle 1 based on a position of the control target. Also, when audio content is being output by a media application through the speaker 133, the controller 300 may be configured to output the sound feedback through the speaker 133 after reducing a volume of the audio content.

The AVN system 210 may be configured to provide an audio function, a video function and a navigation function. For instance, the AVN system 210 may be configured to acquire current location information of the vehicle 1 and guide a driving route to a destination set by the user from a current location. A driving route set by the AVN system 210 may be displayed through the display 130.

The air conditioning system 220 may be configured to condition the air inside the vehicle 1. The air conditioning system 220 may be configured to perform cooling or heating for inside the vehicle 1. The body control system 230 may be configured to control operations of electronic components that provide convenience to the driver or secure the driver safety. For example, the body control system 230 may be configured to control devices such as the window 116, the sunroof 113, the seat 121, the side mirror 118, the trunk 114, the lamp 117, a wiper 101, the cluster 123, a multifunction switch, and a turn signal.

The DAS 240 may be configured to assist the driver's operation (driving, braking, and steering) of the vehicle 1. For instance, the DAS 240 may be configured to detect an environment (e.g., other vehicles, pedestrians, cyclists, lanes, road signs, etc.) around the vehicle 1, and may be configured to control at least one of driving, braking or steering of the vehicle 1 in response to the detected environment. The DAS 240 may be configured to provide at least one of a lane departure warning (LDW), a lane keeping assist (LKA), a high beam assist (HBA), an autonomous emergency braking (AEB), a traffic sign recognition (TSR), a smart cruise control (SCC), and a blind spot detection (BSD).

The controller 300 may be electrically connected to and control the electronic components of the vehicle 1. The controller 300 may include a processor 310 and the memory 320. The memory 320 may be configured to store a program, an instruction and/or an application for performing a vehicle remote control method. The processor 310 may be configured to execute the program, instruction and/or application stored in the memory 320. A plurality of processors 310 and memories 320 may be provided. The controller 300 may include control units such as an electronic control unit (ECU) or a micro controller unit (MCU).

The memory 320 may include a non-volatile memory such as a cache, a read only memory (ROM), a programmable read only memory (PROM), an erasable programmable read only memory (EPROM), and an electrically erasable programmable read only memory (EEPROM), and a flash memory. Also, the memory 320 may include a volatile memory such as a random access memory (RAM) and storage medium such as hard disk drive (HDD) and compact disc read only memory (CD-ROM), without being limited thereto.

In addition to the above-described constituent components, the vehicle 1 may include various devices. Also, a portion of the above-described constituent components may be omitted from the vehicle 1.

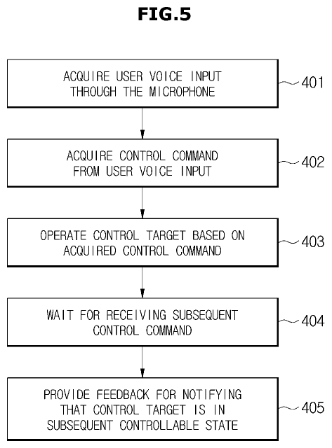

FIG. 5 is a flowchart illustrating a control method of a vehicle according to an exemplary embodiment.

Referring to FIG. 5, the controller 300 of the vehicle 1 may be configured to acquire a user voice input through the microphone 110 (401). The user voice input may be user's utterance including a control command for operating a device of the vehicle 1. The user voice input may include a name of a control target and a command for instructing an operation of the control target. Also, the user voice input may include a word for calling an AI application.

The controller 300 may be configured to identify and/or acquire the control target and the control command by analyzing the user voice input (402). For example, the user voice input for operating the device of the vehicle 1 may be identified as ‘lower the rear right window’. The control target may be identified as ‘the rear right window’, and the control command may be identified as ‘lowering’ or ‘opening’. As another example, the user voice input for operating an air conditioner may be identified as ‘lower the temperature of the air conditioner’. The controller 300 may be configured to identify the control target as ‘the air conditioner’, and the control command as ‘lowering the temperature’.

To analyze the user voice input, a pre-stored conversation model and speech recognition program may be used. The conversation model and speech recognition program may be stored in the memory 320. The conversation model may be trained using a known machine learning algorithm or deep learning algorithm.

The controller 300 may be configured to operate the control target based on the acquired control command (403). For example, the controller 300 may be configured to open the rear right window, based on the control target identified as ‘rear right window’ and the control command identified as ‘opening’. Also, the controller 300 may be configured to control the air conditioning system 220 to decrease the temperature inside the vehicle 1, based on the control target identified as ‘air conditioner’ and the control command identified as ‘lowering the temperature’.

The controller 300 may be configured to wait for receiving a subsequent control command for a predetermined waiting time after operating the control target (404). Also, the controller 300 may be configured to control at least one of the display 130 or the speaker 133 to provide a feedback for notifying that the control target is in a subsequent controllable state for the predetermined waiting time (405).

The controller 300 may be configured to control the display 130 to display at least one of a text or a graphic object representing the control target as visual feedback. The controller 300 may be configured to control the speaker 133 to output a predetermined sound effect related to the control target, as sound feedback. Also, in response to a user voice input calling an AI application, the controller 300 may be configured to control the speaker 133 to output an AI speech, related to the control target which is in the subsequent controllable state, as the sound feedback.

When the user makes an utterance including the subsequent control command within the predetermined waiting time, the controller 300 may be configured to acquire the subsequent control command from the user voice input and operate the control target in response to the subsequent control command. For example, after opening the rear right window in response to the user voice input like ‘lower the rear right window’, a user voice input like ‘close the rear right window’ may be acquired within the predetermined waiting time. The controller 300 may be configured to identify ‘close the rear right window’ as the subsequent control command, and also control the rear right window to be closed.

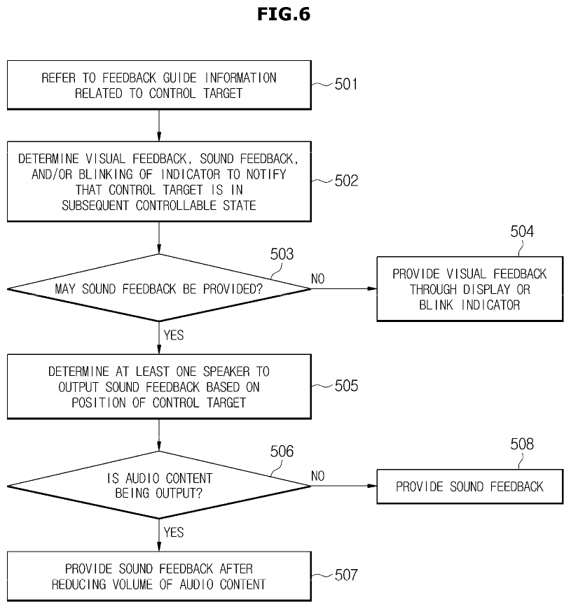

FIG. 6 is a flowchart illustrating a method of providing feedback described in FIG. 5.

Referring to FIG. 6, the controller 300 may be configured to refer to predetermined feedback guide information related to a control target (501). The feedback guide information may be stored in the memory 320 in advance, and may include sound feedback, visual feedback and/or blinking of the indicator 125b matching the control target.

The controller 300 may be configured to determine at least one of providing the visual feedback through the display 130 or providing the sound feedback through the speaker 133, based on the feedback guide information related to the control target, and also determine blinking of the indicator 125b based on the feedback guide information related to the control target (502). The blinking of the indicator 125b may also be included in the visual feedback.

The controller 300 may be configured to determine whether the sound feedback may be provided by referring to the control target and the feedback guide information (503). Based on the visual feedback and/or indicator feedback being defined but the sound feedback not being defined, the controller 300 may be configured to determine providing the visual feedback through the display 130 and/or blinking of the indicator 125b related to the control target (504).

When the sound feedback related to the control target is defined in the feedback guide information, the controller 300 may be configured to determine at least one speaker to output the sound feedback among a plurality of speakers, based on a position of the control target (505). For example, when the control target is the ‘rear right window’, the sound feedback may be output through the rear right speaker 133RR located close to the rear right window. The sound feedback may be output through the speaker 133 located close to the control target, thereby allowing a user to easily recognize the position of the control target which is in the subsequent controllable state.

The controller 300 may be configured to identify whether audio content is being output by a media application, before outputting the sound feedback through the speaker 133 (506). Based on the audio content being output by the media application through the speaker 133, the controller 300 may be configured to provide the sound feedback after reducing a volume of the audio content (507). Accordingly, the user may easily recognize the subsequent controllable state. When the audio content is not being output by the media application, the controller 300 may be configured to control the speaker 133 to output the sound feedback at a predetermined volume or a volume set by the user (508).

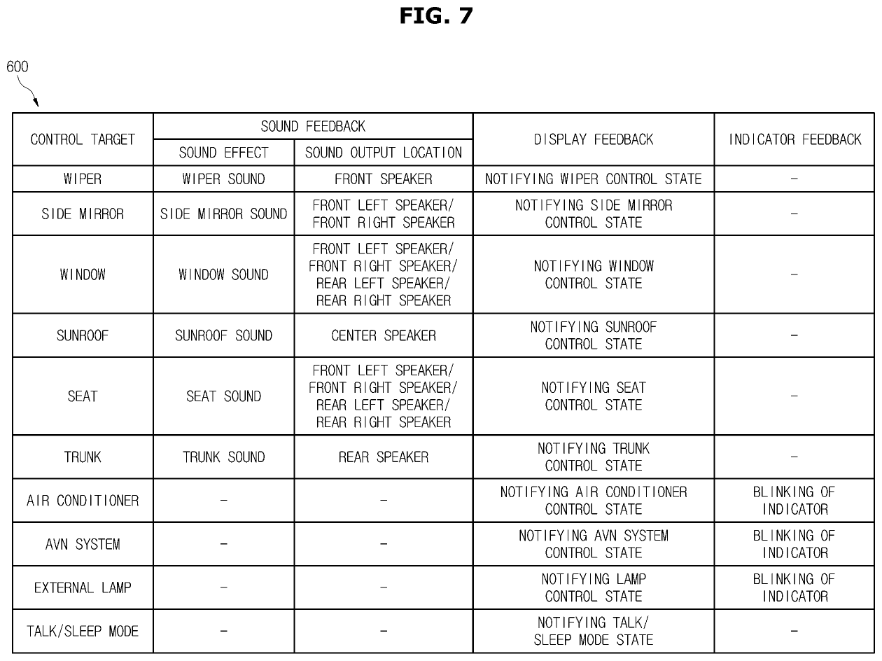

FIG. 7 is a table 600 illustrating feedback guide information related to a control target.

Referring to the table 600 of FIG. 7, the feedback guide information defines visual feedback, sound feedback and blinking of indicator for notifying that the control target is in a subsequent controllable state. The feedback guide information may include a GUI, a sound effect and/or a light emission pattern matched to the control target. The feedback guide information may be stored in the memory 320 in advance. The visual feedback may be provided through the display 130, and may be referred to as display feedback. The sound feedback may be provided through the speaker 133.

A variety of devices and/or functions of the vehicle 1 may be the control target. For example, the control target may be the wiper 101, the side mirror 118, the window 116, the sunroof 113, the seat 121, the trunk 114, the air conditioning system 220, the AVN system 210, the lamp 117, and/or a talk/sleep mode.

With respect to the wiper 101, a sound effect corresponding to a wiper sound may be provided as the sound feedback. The wiper sound may be a wiper motor sound or a sound made when the wiper 101 operates. Because the wiper 101 is positioned on a front window glass, the wiper sound may be output through the front speakers 133F-1, 133F-2, and 133F-3. Also, a GUI for indicating a control state of the wiper 101 may be provided through the display 13.

With respect to the side mirror 118, a sound effect corresponding to a side mirror sound may be provided as the sound feedback. The side mirror sound may be a motor sound of the side mirror 118. Because the side mirror 118 is positioned on front left and right sides of the vehicle 1, the side mirror sound may be output through the front left speaker 133FL and the front right speaker 133FR. Also, a GUI for indicating a control state of the side mirror 118 may be provided through the display 130.

With respect to the window 116, a sound effect corresponding to a window sound may be provided as the sound feedback. The window sound may be a window motor sound or a sound made when the window 116 opens or closes. Because the window 116 may be provided in each of a front left door, a front right door, a rear left door, and a rear right door, the window sound may be output through each of the front left speaker 133FL, the front right speaker 133FR, the rear left speaker 133RL, and the rear right speaker 133RR. When only a portion of the windows 116 is a control target, the sound feedback may be output through the speaker 133 located close to the controlled window 116. Also, a GUI for indicating a control state of the window 116 may be provided through the display 130.

With respect to the sunroof 113, a sound effect corresponding to a sunroof sound may be provided as the sound feedback. The sunroof sound may be a sunroof motor sound or a sound made when the sunroof 113 opens or closes. Because the sunroof 113 may be positioned on a roof of the vehicle 1, the sunroof sound may be output through the center speakers 133CL and 133CR. Also, a GUI for indicating a control state of the sunroof 113 may be provided through the display 130.

With respect to the seat 121, a sound effect corresponding to a seat sound may be provided as the sound feedback. The seat sound may be a seat motor sound or a sound made when the seat 121 moves. Because the seat 121 is positioned on the front left, front right, rear left and rear right sides inside the vehicle 1, the seat sound may be output through the front left speaker 133FL, the front right speaker 133FR, the rear left speaker 133RL, and the rear right speaker 133RR. When only a portion of the seats 121 is a control target, the sound feedback may be output through the speaker 133 located close to the controlled seat 121. Also, a GUI for indicating a control state of the seat 121 may be provided through the display 130.

With respect to the trunk 114, a sound effect corresponding to a trunk sound may be provided as the sound feedback. The trunk sound may be a trunk motor sound or a sound made when the trunk 114 opens or closes. Because the trunk 114 may be positioned in the rear of the vehicle 1, the trunk sound may be output through the rear speaker 133R. Also, a GUI for indicating a control state of the trunk 114 may be provided through the display 130.

As visual feedback with respect to each of the air conditioning system 220, the AVN system 210 and the lamp 117, a GUI configured for indicating that each of the air conditioning system 220, the AVN system 210 and the lamp 117 is in a subsequent controllable state may be displayed through the display 130. Also, the indicator 125b related to each of the air conditioning system 220, the AVN system 210 and the lamp 117 may be configured to blink to notify that each of the air conditioning system 220, the AVN system 210 and the lamp 117 is in a subsequent controllable state. The controller 300 may be configured to control blinking of the indicator 125b based on a predetermined light emission pattern.

Also, the vehicle 1 may be configured to provide various convenient functions. For example, the vehicle 1 may be configured to provide a talk/sleep mode. When the talk/sleep mode is on, outputs and/or volumes of the plurality of speakers 133 may be adjusted. For instance, the controller 300 may be configured to mute or reduce the output and/or volume of each of the rear left speaker 133RL, the rear right speaker 133RR, the rear speaker 133R and the center speakers 133CL and 133CR, so that a voice of an occupant sitting in a front seat is effectively transmitted to a rear seat. The controller 300 may be configured to control the display 130 to display the visual feedback notifying that a subsequent control regarding the talk/sleep mode is available, after executing the talk/sleep mode.

As described above, the feedback notifying the subsequent controllable state for each position and type of the devices and/or functions of the vehicle 1 may be provided. The user may recognize a direction where the sound feedback is output, thereby confirming the position of the control target. Accordingly, the user may identify the control target without losing attention while driving. Also, the user may confirm whether and where the visual feedback is displayed, thereby recognizing whether the control target is in the subsequent controllable state. That is, by providing the feedback notifying the subsequent controllable state of the devices and/or functions of the vehicle 1, the user may easily recognize which object is subsequent controllable with a sound command.

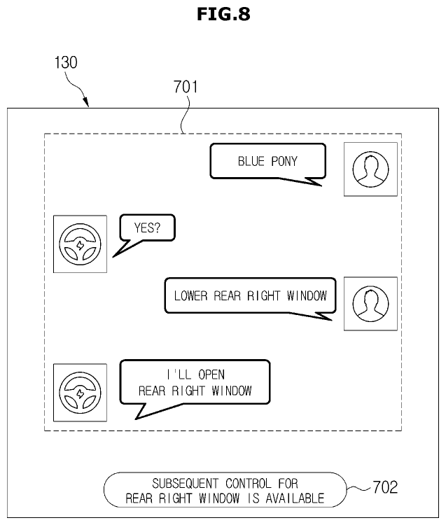

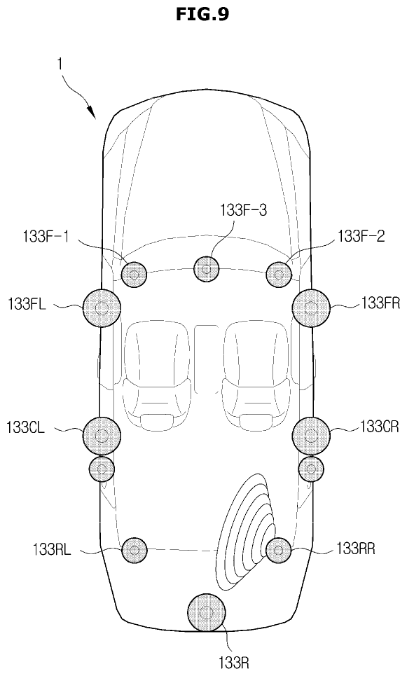

FIG. 8 illustrates an example of visual feedback provided through a display. FIG. 9 illustrates an example of sound feedback provided through a speaker.

Referring to FIG. 8, the controller 300 may be configured to execute an AI application in response to a user voice input calling the AI application. Also, the controller 300 may be configured to control the display 130 to display content of conversation between a user and an AI assistant. For example, when the user says ‘blue pony’, the controller 300 may be configured to execute the AI application, and may be configured to control the display 130 to display an answer of the AI assistant responding to the user voice input. The AI assistant's answer may be output as a voice through the speaker 133.

In response to a user voice input identified as ‘lower the rear right window’, the display 130 may be configured to display the AI assistant's answer such as ‘I'll open the rear right window’. Also, the controller 300 may be configured to identify a control target which is ‘rear right window’ and a control command which is ‘open’ from the user voice input, and control the rear right window to be open.

The controller 300 may be configured to wait for receiving a subsequent control command for a predetermined waiting time, after operating the control target. The controller 300 may be configured to control at least one of the display 130 or the speaker 133 to provide a feedback for notifying that the control target is in a subsequent controllable state for the predetermined waiting time. The controller 300 may be configured to provide a text 702 such as ‘a subsequent control for the rear right window is available’ as visual feedback, in order to notify that the subsequent control for the rear right window is available.

Also, referring to FIG. 9, sound feedback may be output through the rear right speaker 133RR located close to the rear right window among the plurality of speakers 133 provided inside the vehicle 1. For example, an AI speech such as ‘a subsequent control for the rear right window is available’ may be output through the rear right speaker 133RR. Such sound feedback may be provided at predetermined intervals during the waiting time. In addition, the sound feedback may be provided in response to a user voice input calling the AI application.

The user may recognize a window sound output through the rear right speaker 133RR, thereby recognizing that the rear right window is in a subsequent controllable state.

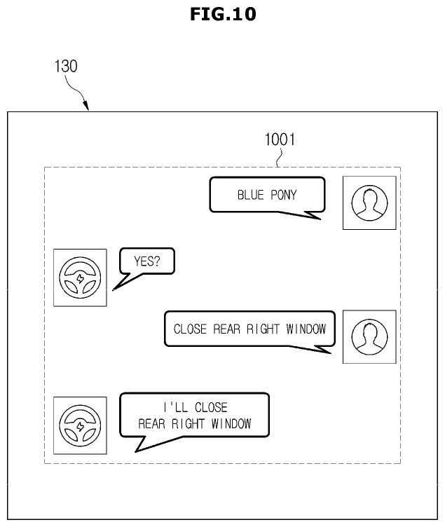

FIG. 10 illustrates an example of an input of a subsequent control command and an operation of a vehicle according to the subsequent control command.

Referring to FIG. 10, the display 130 may be configured to display a screen 1001 including content of conversation between a user and an AI assistant for a subsequent control command of a rear right window. When the user makes an utterance including the subsequent control command within a waiting time, the controller 300 may be configured to acquire the subsequent control command from the user voice input, and may be configured to operate a control target in response to the subsequent control command. For example, the user voice input such as ‘close the rear right window’ may be acquired within the waiting time, after opening the rear right window. The controller 300 may be configured to identify ‘closing the rear right window’ as the subsequent control command, and may be configured to control the rear right window to be closed.

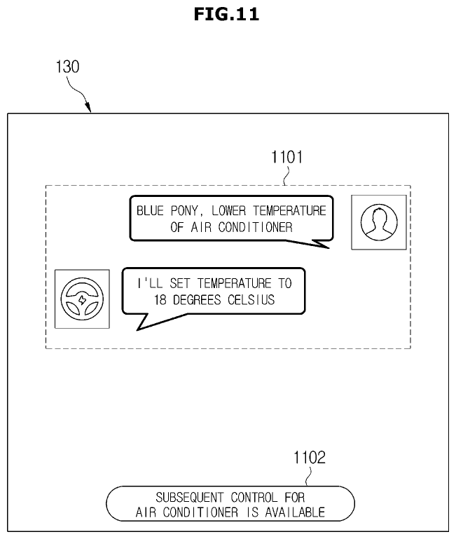

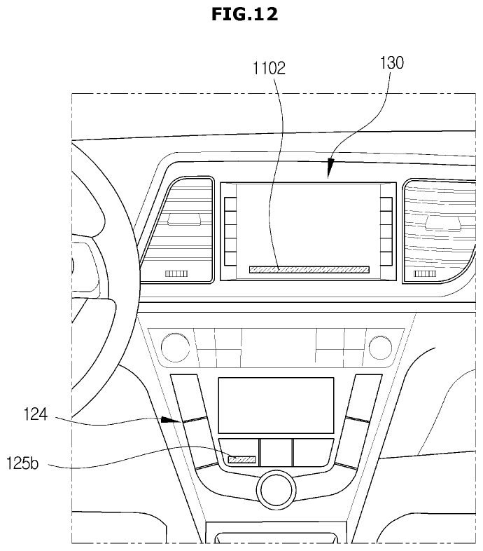

FIGS. 11 and 12 illustrate another example of visual feedback provided through a display.

Referring to FIGS. 11, the display 130 may be configured to display a screen 1101 including content of conversation between a user and an AI assistant for operating an air conditioner. A user voice input for operating the air conditioner may be identified as ‘blue pony, lower the temperature of the air conditioner’.

The controller 300 may be configured to execute an AI application by identifying ‘blue pony’ which is a word for calling the AI application. The controller 300 may be configured to identify a control target as ‘the air conditioner’, and a control command as ‘lowering the temperature’. Based on the identification of the control target as ‘the air conditioner’ and the control command as ‘lowering the temperature’, the controller 300 may be configured to control the air conditioning system 220 to decrease the temperature inside the vehicle 1. A desired inside temperature of the vehicle 1 may be set automatically. For example, the desired inside temperature of the vehicle 1 may be set to 18 degrees Celsius. The AI assistant may be configured to make an utterance such as, e.g., ‘I'll set the temperature to 18 degrees Celsius’.

Also, the controller 300 may be configured to wait for receiving a subsequent control command for the air conditioner for a predetermined waiting time. The controller 300 may be configured to control the display 130 to provide visual feedback for notifying that the air conditioner is in a subsequent controllable state for the predetermined waiting time. For example, the display 130 may be configured to display a text 1102 (visual feedback) such as ‘a subsequent control for the air conditioner is available’.

Referring to FIG. 12, the visual feedback 1102 notifying that the air conditioner is in the subsequent controllable state may be configured to be displayed in a lower portion of a screen of the display 130. Also, the indicator 125b instructing an operation of the air conditioner may blink. The indicator 125b may be configured to blink based on a predetermined light emission pattern.

As described above, the vehicle and the control method thereof may provide feedback for notifying that a be-controlled object is in a subsequent controllable state.

The vehicle and the control method thereof may provide the subsequent controllable state of the control target as at least one of visual feedback or sound feedback, thereby allowing a user to easily recognize which control target is in the subsequent controllable state.

As is apparent from the above, according to the embodiments of the present disclosure, the vehicle and the control method thereof may provide a feedback for notifying that a control target is in a subsequent controllable state.

The vehicle and the control method thereof may provide the subsequent controllable state of the control target as at least one of visual feedback or sound feedback, thereby allowing a user to easily recognize which control target is in the subsequent controllable state. By appropriately providing a feedback notifying the subsequent controllable state of devices and/or functions of the vehicle, the user may easily recognize which control target is in the subsequent controllable state with a voice command.

Embodiments may thus be implemented through computer readable code/instructions in/on a medium, e.g., a computer readable medium, to control at least one processing element to implement any above described exemplary embodiment. The medium may correspond to any medium/media permitting the storing and/or transmission of the computer readable code.

The computer-readable code may be recorded on a medium or transmitted through the Internet. The medium may include read only memory (ROM), random access memory (RAM), magnetic tapes, magnetic disks, flash memories, and optical recording medium.

Although embodiments have been described for illustrative purposes, those skilled in the art will appreciate that various modifications, additions and substitutions are possible, without departing from the scope and spirit of the present disclosure. Therefore, embodiments have not been described for limiting purposes.

What is claimed is:

1. A vehicle, comprising:
a voice receiver configured to acquire a user voice input;
a speaker provided inside the vehicle;
a display provided inside the vehicle; and
a controller configured to control the voice receiver, the speaker and the display,
wherein the controller is configured to:
acquire a control command from the user voice input,
wait for receiving a subsequent control command for a predetermined waiting time after operating a control target based on the control command, and
control at least one of the speaker or the display to provide a feedback for notifying that the control target is in a subsequent controllable state.

2. The vehicle of claim 1, wherein the controller is configured to determine at least one of: providing a visual feedback through the display; or providing a sound feedback through the speaker, based on predetermined feedback guide information related to the control target.

3. The vehicle of claim 2, wherein the controller is configured to control the display to display at least one of a text or a graphic object representing the control target, as the visual feedback.

4. The vehicle of claim 2, wherein the controller is configured to control the speaker to output a predetermined sound effect related to the control target, as the sound feedback.

5. The vehicle of claim 2, wherein the controller is configured to control the speaker to output an artificial intelligence (AI) speech, related to the control target which is in the subsequent controllable state, as the sound feedback, in response to the user voice input calling an AI application.

6. The vehicle of claim 2, wherein:
a plurality of speakers are provided at a plurality of positions inside the vehicle, and
the controller is further configured to determine at least one speaker to output the sound feedback among the plurality of speakers based on a position of the control target.

7. The vehicle of claim 2, wherein the controller is further configured to provide the sound feedback after reducing a volume of audio content, based on the audio content being output by a media application through the speaker.

8. The vehicle of claim 1, further comprising an indicator provided in a center fascia of the vehicle and configured to indicate an operation state of the control target by light emission,
wherein the controller is configured to control the indicator to blink to notify that the control target is in the subsequent controllable state.

9. The vehicle of claim 1, further comprising a button configured to acquire a user input,
wherein the controller is further configured to acquire the control command from the user voice input through the voice receiver or the user input through the button.

10. The vehicle of claim 1, wherein the voice receiver is a microphone.

11. A method for controlling a vehicle, the method comprising:
acquiring a control command from a user voice input;
waiting for receiving a subsequent control command for a predetermined waiting time after operating a control target based on the control command; and
providing a feedback for notifying that the control target is in a subsequent controllable state for the predetermined waiting time, through at least one of a speaker or a display.

12. The method of claim 11, wherein the providing of the feedback comprises at least one of: determining at least one of providing a visual feedback through the display; or providing a sound feedback through the speaker, based on predetermined feedback guide information related to the control target.

13. The method of claim 12, wherein the providing of the visual feedback comprises displaying at least one of a text or a graphic object representing the control target, on the display.

14. The method of claim 12, wherein the providing of the sound feedback comprises outputting a predetermined sound effect related to the control target, through the speaker.

15. The method of claim 12, wherein the providing of the sound feedback comprises outputting an AI speech, related to the control target which is in the subsequent controllable state, through the speaker, in response to the user voice input calling an AI application.

16. The method of claim 12, wherein:
a plurality of speakers are provided at a plurality of positions inside the vehicle, and
the providing of the sound feedback further comprises determining at least one speaker to output the sound feedback among the plurality of speakers based on a position of the control target.

17. The method of claim 12, wherein the providing of the sound feedback further comprises providing the sound feedback after reducing a volume of audio content, based on the audio content being output by a media application through the speaker.

18. The method of claim 11, wherein:
an indicator is provided in a center fascia of the vehicle to indicate an operation state of the control target by light emission, and
the method further comprises controlling the indicator to blink to notify that the control target is in the subsequent controllable state.

19. The method of claim 11, wherein:
a button is provided in a center fascia of the vehicle to acquire a user input, and
the control command is acquired from the user voice input through a voice receiver or the user input through the button.

20. The control method of claim 19, wherein the voice receiver is a microphone.
